(19) United States
(12) Patent Application Publication
(10) Pub. No.: US 2005/0106466 A1
(43) Pub. Date: May 19, 2005

(54) Carbon fiber containing negative electrode for lithium battery

(76) Inventors: Sankar Dasgupta, Mississauga (CA); Rakesh Bhola, Mississauga (CA); James K. Jacobs, Toronto (CA)

Correspondence Address: GOWLING LAFLEUR HENDERSON LLP;Suite 4900, Commerce Court West, Toronto, ON, M5L 1J3, CA

(21) Appl. No.: 11/017,005

(22) Filed: Dec. 21, 2004

Related U.S. Application Data
(63) Continuation-in-part of application No. 10/067,905, filed on Feb. 8, 2002.

(51) Int. Cl. H01M 4/62; H01M 4/66

(52) U.S. Cl. 429/232; 429/217; 429/245

(57) ABSTRACT

The invention basically comprises the addition of a small amount of nanometer sized carbon tubes or fibres grown by high temperature vapour deposition to a meso-phase graphite mixture used for a negative electrode (anode) for a lithium battery. These are referred to herein as “carbon nano-fibres”. According to one embodiment of the present invention, in an anode for a lithium battery having a conductive substrate coated with a pressed compact of spherical graphite and an ion-conducting polymeric binder, an amount of from 1.5 to 12% by weight of carbon nano-fibres is added. The carbon nano-fibres may have an average diameter of around 0.2 μm (200×10⁻⁹ m) a length of from 10 to 20 mm and an inner core diameter of from 65-70 nm. The spherical graphite may be meso-phase graphite and more preferably, the carbon nano-fibres are included in amount of from 2 to 9% by weight.

This Application is a Continuation-In-Part of U.S. patent application Ser. No. 10/067,905 filed Feb. 8, 2002.

### FIELD OF THE INVENTION

This invention relates to electrode structures for lithium batteries and more specifically to carbon-based substrates used in anodes for such batteries.

### BACKGROUND OF THE INVENTION

Lithium batteries are characterized by having lithium ions moving from the anode or the negative electrode to the cathode or the positive electrode when discharging the battery, and the lithium ions are moving in the reverse direction, that is from the cathode to the anode or to the negative electrode when the battery is being charged. The electrochemical reaction is:

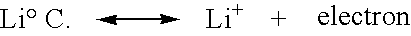

The reaction proceeds from left to right in the discharging step at the anode, and from the right to the left at the cathode or the positive electrode. In the charging step the direction of the movement of the lithium ions is reversed. It is thus clearly illustrated that the anode-active material needs to be capable of reversibly intercalating lithium ions, and have means to conduct the generated electrons away, or in the reverse step supply electrons for intercalation of neutral species. In other words, the anode material needs either to be an electrically conductive material, or have other substances admixed which are electrically (electronically) conductive. The anode may also contain a lithium ion conducting binder material, such as a polyvinyledene fluoride co-polymer or a similar compound.

At the current state of lithium battery technology, there are three major groups of substances, from which an anode active material utilized in a lithium battery may be selected: elemental lithium, intermetallic compounds capable of intercalating lithium ions and graphite crystal bearing carbonaceous materials. The anode material is coated on metal foil, normally copper, which acts as a current collector, is placed in the proximity of a cathode and the electrodes are separated by some form of electrolyte. The cathode is typically a transition metal oxide mixed with fine carbon particles and a binder.

A separator layer of an inert polymer permeable to lithium ions or lithium ions containing non-aqueous liquids is placed between the anode and the cathode to prevent their physical contact. The assemblies are soaked or wetted by a lithium ion containing organic liquid electrolyte, such as LiPF₆ in di-methyl or methyl-ethyl carbonate, and sealed in plastic wrapping to prevent moisture entering the lithium electrochemical cell. The electrolyte may also be a solid, lithium ion conducting polymer layer.

One of the currently utilized anode-active materials is elemental lithium, which is a good source of lithium ions and is a good electrical conductor as well. However, lithium metal is very sensitive to oxidation and when re-deposited in the charging process, elemental lithium may form troublesome dendrites.

The second group of substances which may be selected as anode-active materials in lithium batteries, are intermetallic compounds, such as for example tin-bearing intermetallics, capable of reversibly intercalating lithium ions. Intermetallic compounds suitable for intercalation however, are poor electrical conductors and the tin bearing intermetallic particles need therefore to be admixed with good electrical conductors, such as fine carbon or amorphous carbon fibres.

The third, and most frequently utilized anode-active material is graphitic carbon. Graphitic carbon materials contain graphite crystallites having hexagonal crystal structure, whereby the lithium ions are intercalated forming C₆Li in the hexagonal graphite lattice.

For the carbon particles to intercalate reversibly lithium ions from the electrolyte solution, the carbon must have a particular lattice spacing and be exposed to the electrolyte solution. Graphitic carbon satisfies the lattice spacing requirement, but in its pure form generally will not achieve its theoretical capacity to intercalate lithium ions. It is believed that one cause of this might be the plate-like nature of pure graphite causing bridging and resulting in closed voids which are inaccessible to the electrolyte solution.

Much better results in terms of charge capacity have been observed with the use of what is referred to as “meso-phase” graphite in the anode composition for rechargeable lithium ion batteries. It is believed that as meso-phase graphites are less plate-like and more spheroidal than elemental graphite, they are less prone to forming inaccessible voids than the latter.

Despite advances in rechargeable lithium ion battery technology, there remains a need for such batteries which are better suited to pulsed current demands and improved cycle life capacity. The cycle life capacity is basically a measure of the battery's capacity after charging for repeated charge/discharge cycles. Typically, the capacity diminishes with each charging until a point is reached where the amount of charge becomes insufficient for the battery to provide current for a desired period of time. Presumably the decay in capacity is a reflection of an inability of the graphite to intercalate as many lithium ions as in previous charges. This may be due to breakdown products of the electrolyte blocking or deactivating the active sites of the graphite or to similar disadvantageous side reactions.

Another type of graphitic crystalline carbon is obtained by depositing graphite crystals at very high temperature from the vapor phase in an inert or very low pressure environment. The temperature for high graphitic carbon yield needs to exceed 2000° C. Under such circumstances the graphitic carbon crystallites grow in the form of nano-fibres (fibrils) or nano-tubes. The vapor-grown nano-sized fibres or nano-tubes have very large specific surfaces and are hence very advantageous in readily and reversibly intercalating lithium ions, as well as being good electrical conductors. However, due to the manufacturing conditions, vapor-grown nano-sized tubes and fibres are relatively expensive.

It is noted, that carbon fibres (fibrils) may also be obtained by pyrolysing polymeric thread-like materials or similar hydrocarbon substances in a reducing atmosphere at temperatures in the neighborhood of 1000° C., however, the carbon fibres obtained by pyrolysis or other methods at medium high temperatures, will be predominantly composed of amorphous carbon and are likely to contain substantially lower amounts of hexagonal graphite than vapor-phase graphite nano-fibres deposited at temperatures higher than 2000° C. The carbon fibres obtained at lower temperature are excellent electrical conductors, but are unsuitable for lithium intercalation. Similarly, other amorphous carbon particles, such as soot, carbon black, Shawinigan Black, may be used as electrically conductive additives, but are not recommended as lithium intercalating anode-active materials.

For the sake of clarity, it should be pointed out that it is known to add carbon particles to augment electrical conduction in the cathode or positive electrode. The cathode is usually made of particles of a lithium containing transition metal oxide or sulphide compound, additionally incorporating fine, non-crystalline, conductive, carbon particles. The cathode additive contains an amorphous carbon structure which is not capable of intercalating lithium.

It is known to manufacture the anode of a lithium battery manufactured substantially from nano-sized carbon fibre material. Ikeda et al. in U.S. Pat. No. 5,897,836, issued on Mar. 9, 1999, utilize carbon fibrils (fibres) ranging in length between 3.5 to 75 nm, having preferred aspect ratio above 1000, as anode material in a lithium battery. The carbon fibres used may be catalytically grown or obtained by pyrolysis, then pulverized and mixed with polyethylene or polyethylene fluoride binder in a ratio of 80:20 given as an example. The mixture was subsequently chemically treated and aggregated into a sheet. No information is provided regarding the graphite content of the carbon fibres.

Ohsaki et al. in U.S. Pat. No. 5,856,043, issued on Jan. 5, 1999, teach the use of nano-sized, graphitized, vapor-grown carbon fibres as anode material in a non-aqueous lithium battery. The vapor-grown carbon fibres utilized by Ohsaki are fully graphitized and may be obtained by heat treatment in an inert gas above 2000° C., or by other known means, such as compressing graphitized carbon fibres under hydrostatic pressure. The graphitized vapor-grown carbon fibres are mixed with a fluorinated resin binder material and compacted onto a current collector for use as anode in a lithium battery. The anodes of Ohsaki et al. contain 87-95% graphitized, nano-sized, vapor-grown carbon fibres, it is assumed that the balance is fluorinated resin binder.

U.S. Pat. No. 5,512,393 (Harada et al.) teaches the use of vapour-grown and graphitized non-tubular carbon fibres in an anode however such is used for the entire carbon component of the anode. Furthermore, the dimensions of the fibres are of micron rather than of nanometer size.

As has been discussed above, tin-containing intermetallic compounds have also been known as lithium intercalating substances for use in lithium batteries. Jacobs et al. in U.S. Pat. No. 6,007,945, issued on Dec. 28, 1999, describe particles of titanium dioxide-tin dioxide solid solution as anode-active material, admixed with fine non-crystalline carbon for utilization in the negative electrode of a lithium battery. Nagakiri et al. in U.S. Pat. No. 6,558,841, issued on May 6, 2003, teach tin alloyed or forming a composite with one or more of Group 2 elements, transition metal elements, Group 12 elements, Group 13 and Group 14 elements of the Periodic Table, as lithium storing anode-active components of the negative electrode of a lithium battery. The surface of the anode-active particles is coated, preferably completely, with an electronically conductive material, such as a carbonaceous material. The conductive carbonaceous material preferably contains carbon fibres obtained by thermal decomposition in a reducing atmosphere at around 1000° C. The role of carbon fibres in Nagakiri et al. is conduction of electrons. It is believed, that the presence of notable portions of crystalline graphitic carbon, such as vapor-grown graphitic nano-fibres, in the carbonaceous coating of the intermetallic particles, would interfere with the lithium ion intercalation process of the anode-active intermetallic particles of Nagakiri et al.

The foregoing references teach carbon fibres or carbon nano-fibres as the only lithium intercalating anode active material, or alternatively, tin-bearing intermetallics coated with non-intercalating conductive carbon fibres, as active components of a negative electrode of lithium batteries.

### SUMMARY OF THE INVENTION

The invention comprises the addition of a small amount of nanometer sized graphitic carbon tubes or fibres grown by vapour deposition at temperatures around 2000° C. or higher, to a graphitic mixture, such as a spherical graphite containing mixture used as anode-active component of a negative electrode of a lithium battery.

It is noted for the sake of clarity, that nanometer sized, vapour-grown graphitic carbon tubes or fibres will be referred to hereinbelow as “carbon nano-fibre”.

According to the present invention, in an anode for a lithium battery having a conductive substrate coated with a pressed compact of spherical graphite and an ion-conducting polymeric binder, an amount of from 1.5 to 12% by weight of carbon nano-fibres is added.

The carbon nano-fibres may have an average diameter of around 0.2 μm (200×10⁻⁹ m), length of from 10 to 20 μm and, inner core diameter of from 50-80 nm. This corresponds to an aspect ratio of from 50 to 100. The spherical graphite may be meso-phase graphite and more preferably, the carbon nano-fibres are included in amount of from 2 to 9% by weight.

The carbon nano-fibres may be subject to vacuum at a heat treating temperature prior to or after mixing with the spherical graphite.

According to one embodiment of the present invention, the carbon nano-fibres may be heat and vacuum treated prior to mixing with the meso-phase carbon, in which case the heat treating temperature may be from 40° C. to 140° C.

According to another embodiment of the invention, the heat and vacuum treating may be carried out after preparation of the mixture of carbon nano-fibres, meso-phase carbon particles, ionic binder and wetting of the mixture with lithium ion containing solution. According to this embodiment, the heat treating temperature may be from 45° C. to 80° C.

The vacuum may be less than 10 torr.

The duration of heat and vacuum treatment may be from 2 to 8 hours.

### DESCRIPTION OF DRAWINGS

Preferred embodiments of the present invention are described below with reference to the accompanying drawings in which:

FIG. 1 is a scanning electron micrograph (“SEM”) picture of vapour grown carbon fibres of the type used in the present invention;

FIG. 2 is a scanning electron micrograph picture corresponding to FIG. 1 but at a different magnification; and,

FIG. 3 is a graph illustrating the improved cycle-life of a rechargeable lithium battery made in accordance with the present invention.

### DETAILED DESCRIPTION OF THE INVENTION

According to the present invention, a negative electrode (anode) for a lithium battery is produced by combining a mixture of approximately 95% by weight graphite and 5% by weight ion-conducting polymeric binder to form a coating which is subsequently applied to a current collector, such as copper foil. The graphite is preferably a spherical graphite such as mesocarbon microbeads to which an amount of about 1.5% to about 12% of carbon nano-fibres has been added. The graphite/binder mixture is compressed into a pressed compact with copper foil on one side and a suitable separator on the other side. The separator, as described in the background above is preferably an inert polymer permeable to lithium ions or lithium ion containing non-aqueous liquids.

Suitable results have been obtained using commercially available carbon nano-fibres, such as for example, VGCF-G (Vapour Grown Carbon Fibres) marketed by the Showa Denko Company, which are pretreated nanometer-sized carbon tubes or fibres grown by high temperature vapour deposition. Such have an average diameter of the order of 200 nm (0.2 μm or 200×10⁻⁹ m), an elongated structure with an average length of from 10 to 20 μm and an inner core diameter of from 65-70 nm.

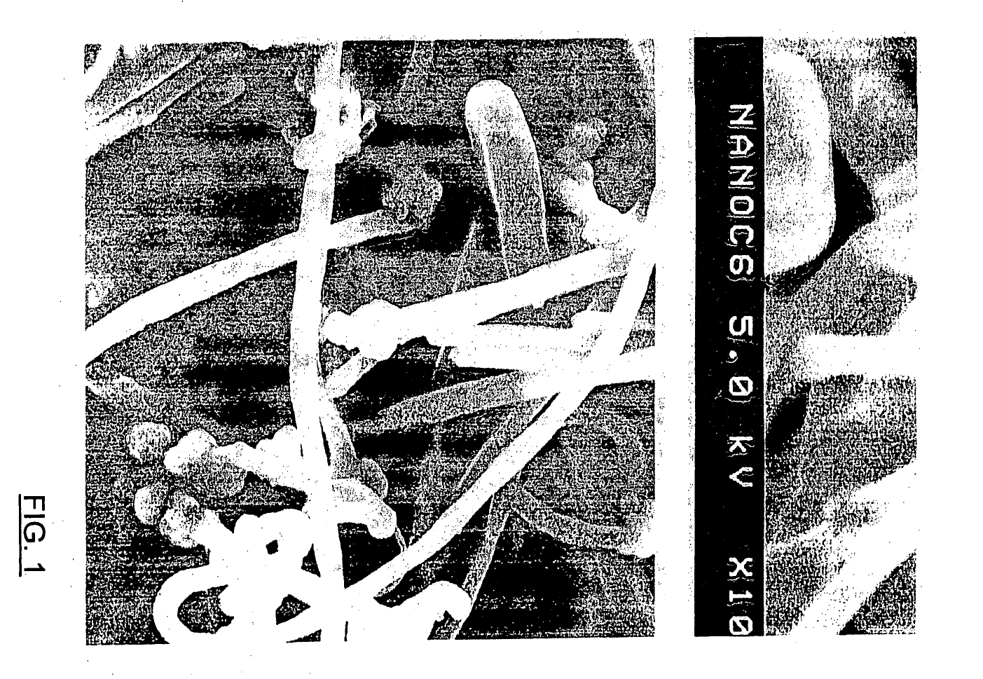

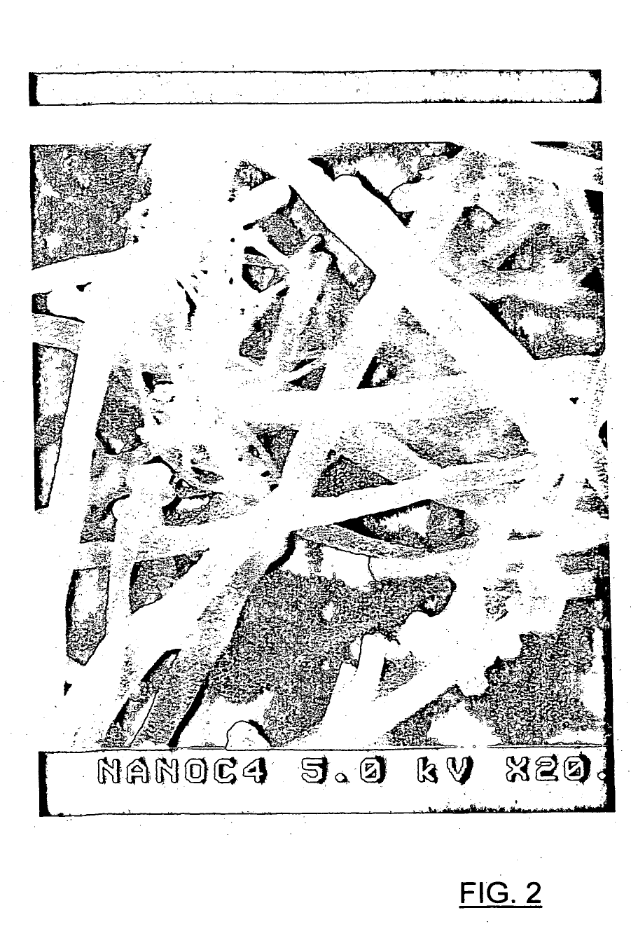

FIGS. 1 and 2 are SEM (scanning electron micrograph) pictures of typical vapour grown carbon fibres. FIG. 1 indicates 0.3 μm (300 nm) scale. FIG. 2 indicates a 1.5 μm scale.

In the preferred embodiment, the carbon nano-fibres are treated in vacuum at temperatures above 40° C. and mixed with commercially available graphitic mesophase carbon micro-beads (MCMB) and binders in a conventional manner. The preferred amount of carbon nano-fibres in the anode mixture ranges between 1.5-12% by weight, the more preferred amount being 2-9% by weight. Cost considerations currently favour a range of between 2-2.5% by weight on account of what is presently a very high cost of this material.

Use of the above mixture in an anode for a lithium battery has been found to yield an initial impedance similar to that without the addition of the carbon nano-fibres, however drastic cycle life increases are possible. Furthermore rate capacity, particularly for pulsed current, is much better. It has further been found that if the carbon nano-fibres are heated in a partial vacuum at heat treatment temperatures of from 40° C. to 140° C., prior to mixing with the graphitic MCMB for from 2 to 8 hours (depending on the selected temperature of the treatment), further significant cycle life increases are obtainable. The vacuum applied may be less than about 10 torr and preferably about 1 torr (1 mm of Hg).

Alternatively, the graphitic MCMB and ionic binder may be premixed and wetted with the lithium ion containing electrolyte solution, and subsequently heat and vacuum treated. In this case, the maximum heat treatment temperature should not exceed 80° C. in order to avoid damage to any organic constituents and the present preferred range is from 45° C. to 80° C. The duration of treatment may be from 2 to 8 hours depending on the selected temperature of the treatment.

The invention is further illustrated by reference to the examples below.

### EXAMPLE 1

Nano-sized carbon fibres, marketed as VGCF-G by the Showa Denko Company, were heated in a vacuum for 3 hours at 125° C., and subsequently allowed to cool in vacuum. The treated nano-carbon fibrils were added to commercially available graphitic mesophase carbon micro-beads (MCMB) in 2.5 wt. % and additionally mixed with an ionically conductive polyvinylidene fluoride binder, marketed under the trade-name of Kynar, in 5 wt %. The mixture obtained was spread over copper foil in 200 μm thickness for use as negative electrode (anode) in a rechargeable lithium electrochemical cell. The lithium electrochemical cell having the above anode, further included a microporous polyethylene separator marketed by the Tonen Co. under the name of ‘Setella’, and a cathode or positive electrode, containing lithium-maganese oxide particles carried on an aluminum foil current collector. The assembled electrochemical cell was subsequently impregnated with ethylene carbonate-dimethyl carbonate electrolyte containing LiPF₆ in 1 M concentration, and sealed in a multi-layered protective polymer wrapping in the usual manner.

### EXAMPLE 2

Nano-sized carbon fibres, marketed as VGCF-G by the Showa Denko Company, were added to commercially available graphitic mesophase carbon micro-beads (MCMB) in 3 wt % and additionally mixed with an ionically conductive polyvinylidene fluoride binder, marketed under the trade name of Kynar, in 5 wt %. The above mixture was wetted with a small amount of ethylene carbonate-dimethyl carbonate electrolyte containing LiPF₆ in 1 M concentration, and further mixed to yield an anode paste. The obtained paste was subsequently heated in a vacuum of 5 torr for 6 hours at 55° C., and subsequently allowed to cool in vacuum. The mixture obtained was spread over copper foil in 200 μm thickness for use as negative electrode (anode) in a rechargeable lithium electrochemical cell. The lithium electrochemical cell having the above anode additionally included a microporous polyethylene separator marketed by the Tonen Co. under the name of ‘Setella’ and a cathode or positive electrode, containing lithium-maganese oxide particles carried on an aluminum foil current collector. The assembled electrochemical cell was subsequently impregnated with ethylene carbonate-dimethyl carbonate electrolyte containing LiPF₆ in 1 M concentration, and sealed in a multi-layered protective polymer wrapping in the usual manner.

### EXAMPLE 3

Nano-sized carbon fibres, marketed as VGCF-G by the Showa Denko Company, were added to commercially available graphitic mesophase carbon micro-balls (MCMB) in 3 wt. % and additionally mixed with an ionically conductive polyvinylidene fluoride binder, marketed under the trade name of Kynar, in 5 wt %. The above mixture was wetted with a small amount of ethylene carbonate-dimethyl carbonate electrolyte containing LiPF₆ in 1 M concentration, and further mixed to yield an anode paste. The obtained paste was subsequently heated in a vacuum of 3 torr for 4 hours at 65° C., and subsequently allowed to cool in vacuum. The mixture obtained was spread over copper foil in 200 μm thickness for use as negative electrode (anode) in a rechargeable lithium electrochemical cell. The lithium electrochemical cell having the above anode additionally included a microporous polyethylene separator marketed by the Tonen Co. under the name of ‘Setella’ and a cathode or positive electrode, containing lithium-cobalt oxide particles carried on an aluminum foil current collector. The assembled electrochemical cell was subsequently impregnated with ethylene carbonate-dimethyl carbonate electrolyte containing LiPF6 in 1 M concentration, and sealed in a multi-layered protective polymer wrapping in the usual manner.

### EXAMPLE 4

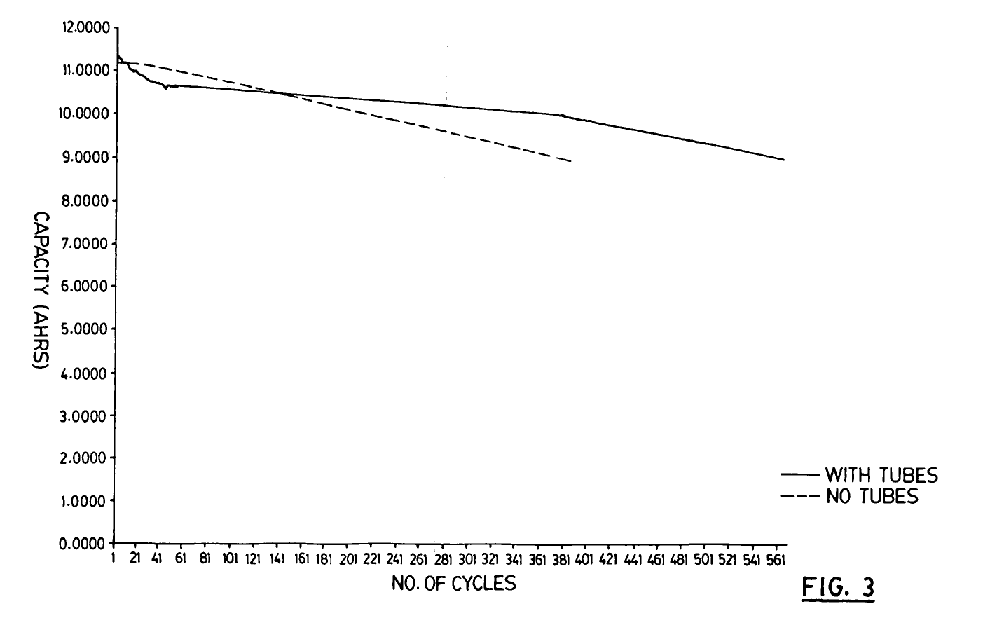

Rechargeable lithium batteries having carbon nano-fibre containing anodes and assembled as described in Example 3 were compared in performance to conventional graphite anode containing rechargeable lithium batteries. The lithium batteries tested were first charged to 4.2 volt at 1.75 ampere current to reach 3.0 volt. The lithium battery capacity in ampere hours (A/hrs) was plotted against the number of charging-discharging cycles attained, and the obtained graph is shown on FIG. 3. It can be seen that the performance of the carbon nano-fibre (nano-tubes) bearing lithium battery notably out-performs the conventionally made lithium battery.

The above description is intended in an illustrative rather than a restrictive sense. Variations to the exact description may be apparent to those skilled in the relevant art without departing from the spirit and scope of the invention as defined by the claims set out below.

1. In an anode for a lithium battery having a conductive substrate coated with a pressed compact of spherical graphite and an ion conducting polymeric binder, the improvement comprising:
the inclusion of up to from 1.5 to 12% by weight of carbon nano-fibres in said pressed compact.

2. The anode of claim 1 wherein:
said spherical graphite is meso-phase carbon micro-balls;
said carbon nano-fibres have an average diameter of about 200 nm, a length of from 10 to 20 mm and an inner core diameter of 65 to 70 nm.

3. The anode of claim 2 wherein:
said carbon nano-fibres are included in an amount of from 2% to 9% by weight.

4. The anode of claim 3 wherein:
said carbon nano-fibres are pre-treated vapour grown carbon fibres.

5. The anode of claim 4 wherein:
said nano-fibres were subject to vacuum at a heat treatment temperature of from 40° to 140° C. for a period of from 2 to 8 hours prior to mixing with said spherical graphite.

6. The anode of claim 4 wherein:
said nano-fibres were subject to vacuum at a heat temperature of from 45° to 80° C. for a period of from 2 to 8 hours after mixing with said spherical graphite.

7. The anode of claim 6 wherein:
said conductive substrate is copper foil.

8. In a non-aqueous lithium battery having an anode of a conductive substrate coated with a pressed compact of spherical graphite and an ion conducting polymeric binder, the improvement comprising:
the inclusion of up to from 1.5 to 12% by weight of carbon nano-fibres in said pressed compact.

9. The lithium battery of claim 8 wherein:
said spherical graphite is meso-phase carbon micro-balls;
said carbon nano-fibres have an average diameter of about 200 nm, a length of from 10 to 20 mm and an inner core diameter of 65 to 70 nm.

10. The lithium battery of claim 9 wherein:
said carbon nano-fibres are included in an amount of from 2% to 9% by weight.

11. The lithium battery of claim 10 wherein:
said carbon nano-fibres are pre-treated vapour grown carbon fibres.

12. The lithium battery of claim 11 wherein:
said nano-fibres were subject to vacuum at heat treating temperatures of from 40° C. to 140° C. prior to mixing with said spherical graphite.

13. The lithium battery of claim 12 wherein:
said nano-fibres were subject to vacuum at heat treating temperatures of from 45° C. to 80° C. after mixing with said spherical graphite.

14. The lithium battery of claim 11 wherein:
said conductive substrate is copper foil.

15. The anode of claim 5 wherein:
said vacuum is from 1 torr (1 mm of Hg) to 10 torr (10 mm of Hg).

16. The lithium battery of claim 12 wherein:
said vacuum is from 1 torr (1 mm of Hg) to 10 torr (10 mm of Hg).

17. The anode of claim 6 wherein:
said vacuum is about 1 torr (1 mm of Hg).

18. The lithium battery of claim 12 wherein:
said vacuum is about 1 torr (1 mm of Hg).

19. A rechargeable lithium battery having an anode containing graphite as an electro-active component and wherein:
said graphite comprises from about 1.5 to 12% by weight of carbon nano-fibres.
